(19) United States
(12) Patent Application Publication
(10) Pub. No.: US 2014/0040423 A1
(43) Pub. Date: Feb. 6, 2014

(54) Obtaining and Presenting Data to Web Properties

(71) Applicant: Eu-Jin GOH, Palo Alto, CA (US)

(72) Inventor: Eu-Jin GOH, Palo Alto, CA (US)

(73) Assignee: Google Inc., Mountain View, CA (US)

(21) Appl. No.: 13/564,685

(22) Filed: Aug. 1, 2012

(51) Int. Cl. G06F 15/16

(52) U.S. Cl. 709/217

(57) ABSTRACT

Systems, methods and apparatus are provided including a method that identifies when a content item that was presented to a user in association with a slot on a resource is not visible to the user, wherein the slot presenting the content item is rendered wholly or partially not visible as a result of user activity. The method further includes receiving a request to provide an alternative content item to be presented to the user when user activity enables re-presentation of the slot and delivering the alternative content item to a device associated with the user responsive to the request.

### BACKGROUND

This specification relates to information processing.

The Internet provides access to a wide variety of resources. For example, video and/or audio files, as well as web pages for particular subjects, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Content item slots can be allocated to content sponsors through prices offered by content sponsors as part of a reservation system, or by bid amounts used in an auction. For example, content sponsors can provide bids specifying amounts that the sponsors are respectively willing to pay for presentation of their content. In turn, an auction can be performed, and the slots can be allocated to sponsors according to, among other things, their bids and/or the relevance of the sponsored content to content presented on a page hosting the slot or a request that is received for the sponsored content.

### SUMMARY

In general, one innovative aspect of the subject matter described in this specification can be implemented in a methods that includes identifying when a content item that was presented to a user in association with a slot on a resource is not visible to the user, wherein the slot presenting the content item is rendered wholly or partially not visible as a result of user activity. The method further includes receiving a request to provide an alternative content item to be presented to the user when user activity enables re-presentation of the slot and delivering the alternative content item to a device associated with the user responsive to the request.

These and other implementations can each optionally include one or more of the following features. The method can further include providing a script to the resource that, when executed, identifies if the slot is wholly or partially obscured. The script can be a tag that fires to request a content item from a content delivery system. The script can be a tag that monitors user activity and detects when the slot is wholly or partially obscured. The script can determine when the slot is below a lower boundary associated with a user interface that presents the resource, and wherein delivering the alternative content item occurs prior to user activity that results in the slot surfacing above the lower boundary. The script can track user activity and determines when the user activity results in the slot being wholly or partially obscured. The request can include a request for a content item to fill the slot based at least in part on a result from a prior auction. Receiving the request and delivering the alternative content item can occur while the content slot is no longer visible to the user.

In another aspect a method is provided that includes, in a client device, identifying a content slot including present content for presentation to a user viewing a resource. The method further includes determining when a user activity results in the present content either wholly or partially no longer being visible to the user. While the present content is no longer visible, the method includes requesting alternative content for displaying in the content slot and receiving the alternative content. After receiving the alternative content, the method further includes presenting the alternative content when user activity results in the visibility of the content slot.

These and other implementations can each optionally include one or more of the following features. The method can further include receiving a script that, when executed, identifies if the content slot is wholly or partially obscured. The script can be a tag that fires to request content from a content delivery system. The script can be a tag that monitors user activity and detects when the content slot is wholly or partially obscured. The script can determine when the content slot is below a lower boundary associated with a user interface that presents the resource, and wherein receiving the alternative content occurs prior to user activity that results in the content slot surfacing above the lower boundary. The script can track user activity and determine when the user activity results in the content slot being wholly or partially obscured. Requesting alternative content can include requesting content to fill the content slot based at least in part on a result from a prior auction. Requesting alternative content and receiving the alternative content can occur while the content slot is no longer visible to the user.

Other embodiments of this aspect include corresponding systems, apparatus, and computer programs, configured to perform the actions of the methods, encoded on computer storage devices.

Particular implementations may realize none, one or more of the following advantages.

The subject matter described in this specification can provide more and different content items (e.g., advertisements) to a user on a web property without requiring the web property to be refreshed or requiring a new web property to be loaded and presented to the user.

The details of one or more embodiments of the subject matter described in this specification are set forth in the accompanying drawings and the description below. Other aspects, features, and advantages of the invention will become apparent from the description, the drawings, and the claims.

### DESCRIPTION OF DRAWINGS

FIG. 1 is a diagram of an example system for providing content to a web property.

FIG. 2A is a schematic diagram of a viewport displaying a portion of a web property.

FIG. 2B is a schematic diagram of the viewport of FIG. 2A displaying another portion of the web property.

FIG. 3 is a flow chart of an example process for delivering content to a user.

FIG. 4 is a flow chart of an example process for receiving and presenting content to a user.

FIG. 5 is a diagram of an example computing system.

Like reference symbols in the various drawings indicate like elements.

### DETAILED DESCRIPTION

When a user navigates to a webpage, a content item (e.g., an advertisement) presented to the user may be refreshed and replaced when, due to user activity, the content item is no longer visible (either wholly or partially) to the user. In some cases, the content item may be replaced automatically when a content slot in which the content item is presented is not visible. Thus, if the user navigates back to a portion of the webpage in which the content slot is presented, a new content item can (i.e., if certain criteria are met) be displayed to the user.

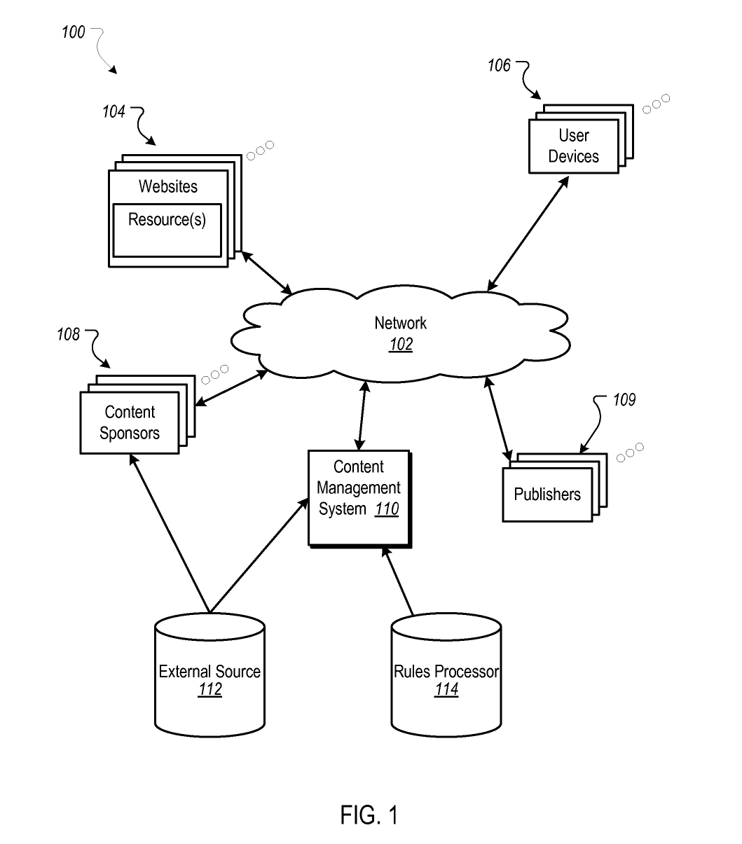

FIG. 1 is a block diagram of an example environment 100 for delivering content. The example environment 100 includes a content management system 110 for selecting and providing content in response to requests for content. The example environment 100 includes a network 102, such as a local area network (LAN), a wide area network (WAN), the Internet, or a combination thereof. The network 102 connects webpages 104, user devices 106, content sponsors 108 (for example, advertisers), content publishers 109, and the content management system 110. The example environment 100 may include many thousands of webpages 104, user devices 106, content sponsors 108, and content publishers 109. User devices 106 may includes various systems or devices used to present electronic information or data to a user, such as various forms of digital computers (e.g., desktops, workstations, game consoles, set-top boxes, and other computing devices), mobile computing device (e.g., laptop computers, tablet computers, personal digital assistants, cellular telephones, smart-phones, media players, and other similar mobile computing devices), or other electronic devices suitable for presenting information (e.g., web properties).

In some examples, a user can request content (e.g., webpages, articles, discussion threads, music, video, graphics, search results, web page listings, information feeds, map content, etc.) from a content publisher 109, for example, via a web browser on user device 106. Responsive to the request, the publisher 109 retrieves (directly or indirectly) the requested content (e.g., a webpage) for the user. The content publisher 109 may return the webpage with a url redirect that directs the web browser to a content management system 100 to obtain content items (e.g., advertisements). Based on the redirect, the web browser may send a request for content items to the content management system 110. Responsive to the request for content items, the content management system 110 can send, for example, an advertisement to be displayed on the webpage within the web browser.

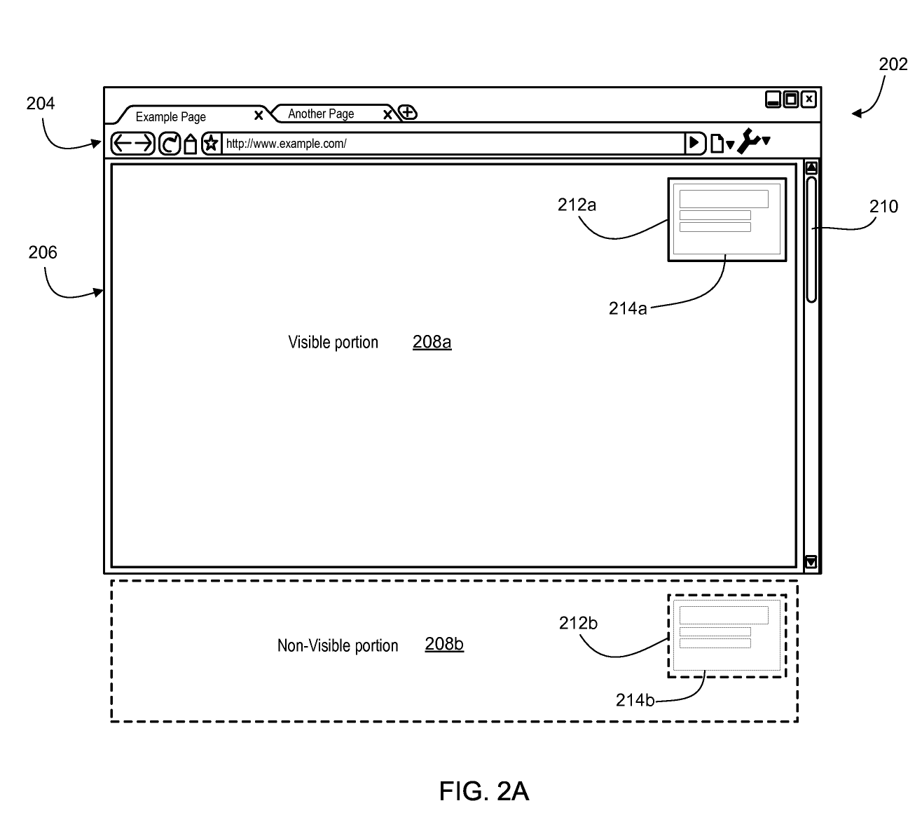

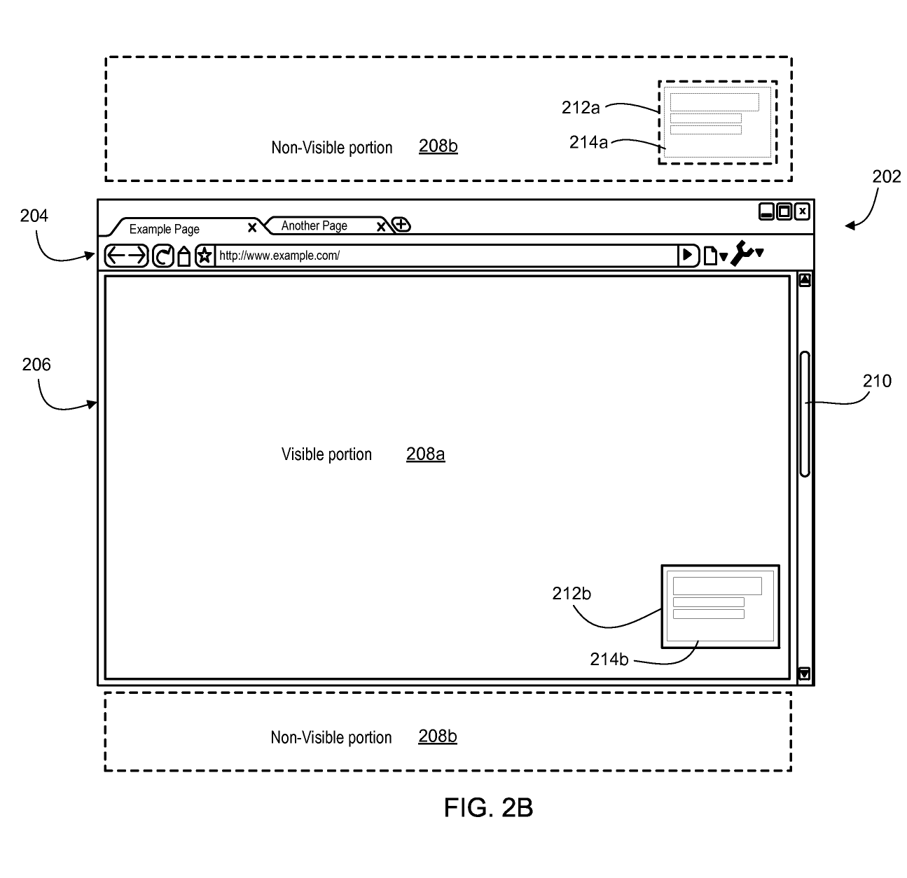

FIG. 2A is a schematic diagram of a web browser 202 that is configured to present and display web properties (e.g., webpages) on a user device. The web browser 202 includes a toolbar 204 that can be used to navigate to and from various web properties. The toolbar 204 may include a web address bar in which a URL or address can be entered, as well as other buttons or navigation tools (e.g., a back button, a forward button, a home button, and other selectable buttons). The toolbar 204 can also include buttons or selectable pulldown menus that may be used to adjust various browser or system settings.

The web browser 202 also includes a viewport 206 in which a webpage may be visibly presented to a user. The size of the viewport 206 may depend on requirements and parameters of the web browser 202 or, alternatively, the user device 106 on which the web browser 202 is operating. In some cases, the total size of the web browser 202 may be adjusted by a user, which may result in an adjustment in the size of the viewport 206.

As shown, the web browser 202 may be used to display a webpage 208. Depending on the size of the webpage 208 and the viewport 206, a first portion of the webpage 208a may be visible within the viewport 206 while a remaining, non-visible portion 208b of the webpage may not be visible to the user. The web browser 202 includes, for example, a scroll bar 210 to re-position the webpage 208 relative to the viewport 206 so as to change which portion of the webpage 208 is visible in the viewport 206. A lower boundary of the visible portion 208a is generally defined by a lower boundary of the viewport 206. In some implementations, the lower boundary of the visible portion 208a when the webpage 208 is initially loaded can be referred to as the “fold,” and the visible portion 208a is referred to as “above the fold” and the non-visible portion 208b is “below the fold.” While reference is made to specific orientations (e.g., above and below the fold), other orientations are possible (e.g., including left and right of a vertical fold line). As a user scrolls up and down along the webpage using the scroll bar 210, portions of the webpage (e.g., content items on the webpage) may be positioned in the visible portion 208a or in the non-visible portion 208b. For example, FIG. 2A shows a first content slot 212a for presenting a first content item 214a that, in the orientation shown, is visible to the user in the visible portion 208a. A second content slot 212b for presenting a second content item 214b is, based on the size of the viewport 206 and the spacing between the first content slot 212a and the second content slot 212b, arranged within the non-visible portion 208b (e.g., below the fold).

FIG. 2B is a schematic diagram of the web browser 202 displaying a different portion of the webpage than displayed in FIG. 2A. As shown, when the scroll bar 210 is moved downward, the webpage may be re-positioned upward accordingly. In this example, the first content slot 212a and the first content item 214a have been moved upward with respect to the viewport, are no longer in the viewport 206 and are therefore in a non-visible portion 208b. The second content slot 212b and second content item 214b have also been moved upward, are positioned within the viewport 206 and are therefore visible within the visible portion 208a.

While the re-positioning of the webpage relative to the viewport 206 has been described and illustrated as the webpage content moving vertically, other orientations are possible. For example, webpages may be wider than the viewport 206 and the webpage may be re-positioned horizontally relative to the viewport 206.

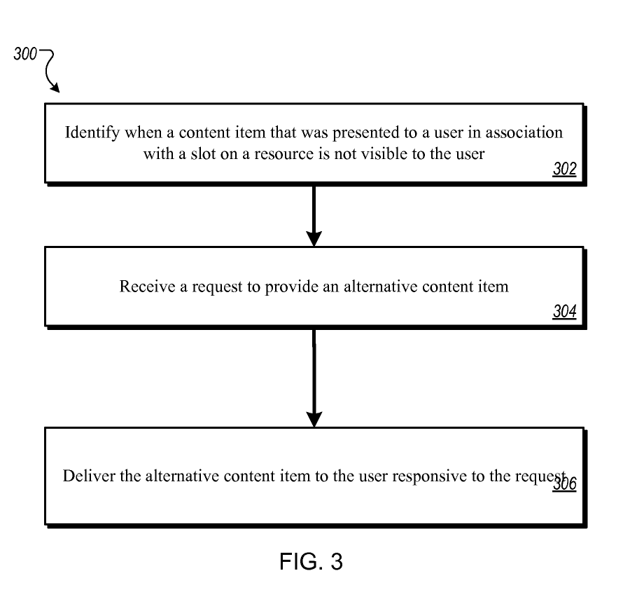

FIG. 3 is a flowchart of an example process 300 for delivering and presenting content items to a user. The process 300 can be implemented as one or more computer programs which are stored on computer-readable media and are executable by data processing apparatuses to perform the operations of the process 300. A content item that has been presented to a user in association with a slot on a resource that is no longer visible to the user is identified (302). For example, the content management system 110 can identify when a content item (e.g., a first content item 214a) that was previously presented to a user in association with a slot (e.g., a first content slot 212a) on a resource (e.g., a webpage) is no longer visible to a user, as a result of user activity. In some implementations, the content item 214a is no longer visible as a result of the user navigating (e.g., scrolling) the viewport 206 of a user interface (e.g., a web browser 202) so that the first content item 214a is no longer visible in the viewport 206 (shown in FIG. 2B). In some implementations, the content item is wholly or partially obscured (e.g., not visible by the user) as a result of the user moving or covering the web browser on which the resource is presented. For example, the user may obscure the web browser by minimizing the web browser, opening an additional computer program, window, or browser that covers the web browser presenting the content item. Alternatively, the user may obscure the web browser by locking or temporarily closing the display of the user device 106 (e.g., by logging off or locking a display on an operating system) or by logging into an account from another user device.

The user activity, which results in the slot being obscured can be monitored in various ways. In some implementations, the resource includes a script, such as a piece of code (e.g., Javascript code) that, when executed, identifies if the slot is wholly or partially obscured (e.g., not visible by the user). In some implementations, the script is a tag that fires to request a content item from the content delivery system. In some implementations, the script is a tag that is able to monitor user activity and detect when the slot is wholly or partially obscured. In some implementations, the script records user activity and determines when the user activity results in the slot being wholly or partially obscured. For example, in some implementations, the script can determine the height of the viewport 206 and the vertical position and height of the content slot (e.g., the first content slot 212a) presented on a web property in the viewport 206. The script can also monitor and determine the amount (e.g., distance) that the user has navigated (e.g., scrolled using the scroll bar 210) from the top of the web property. Using the determined viewport height, location and height of the content slot, and navigation by the user, it can be determined when the content slot is no longer completely or partially located in the visible portion 208a. In some embodiments, the script may monitor and determine when the viewport 206 is resized (e.g., when a user adjusts the size of the web browser 202). In addition to recording adjustments to the size of the viewport, in some embodiments, the script may also determine when the web browser 202 itself is obscured. For example, in some cases, when a web browser is minimized on a computer screen, some types of web browsers change size dimension to a fixed value. The script can monitor and detect such a change in web browser size and determine that the web property displayed in the web browser is obscured and not visible to the user. In some embodiments, the script may also determine when the web browser is wholly or partially obscured by another window (e.g., another program or another web browser) and is not generally visible to the user.

A request for an alternative content item to be presented to the user is received (304). For example, the content management system 110 can receive a request for an alternative content item to be presented to the user when the user's activity enables re-presentation of the slot that was previously obscured by the user activity. In some implementations, the user may scroll down in a web browser 202 so that a slot (e.g., the first content slot 212a) in which a content item (e.g., the first content item 214a) is presented becomes no longer visible (e.g., as a result of being removed from the visible portion 208a). If the users scrolls back upwards in the web browser 202 so that the first content slot 212a is again visible in the visible portion 208a, the content management system 110 may receive a request to provide an alternative content item (i.e., to replace the first content item 214a) to be presented in the first content slot 212a. In some implementations, the request may include a request for a content item to fill the content slot based at least in part on a result from a prior auction. For example, if a slot (e.g., the first content slot 212a), before it is obscured, is presented with a content item from an auction winner, then the content management system 110 may receive a request for an alternative content item from another content sponsor that participated in the auction (e.g., the content sponsor that placed second in the auction).

An alternative content item is delivered (306). For example, the content management system 110 may deliver the alternative content item responsive to the request for alternative content. In some implementations, the request is received and the alternative content item is delivered while the content item is no longer visible to the user (e.g., while the first content slot 212a is still in a non-visible portion 208b). Typically, payment for the alternative content item is not charged until the user scrolls back up so that the alternative content item is visible. However, other payment processes are possible. In some implementations, the script may determine when the content slot is below a lower boundary of the viewport 206 that presents the resource, and the content item is delivered to the content slot prior to user activity that results in the slot surfacing in the view port of the web browser (e.g., above the lower boundary of the viewport 206 and being visible to the user). For example, once the content slot is obscured, the content management system 110 may receive the request for an alternative content item and subsequently deliver the alternative content item to the content slot (i.e., as opposed to waiting until the slot is re-presented to the user).

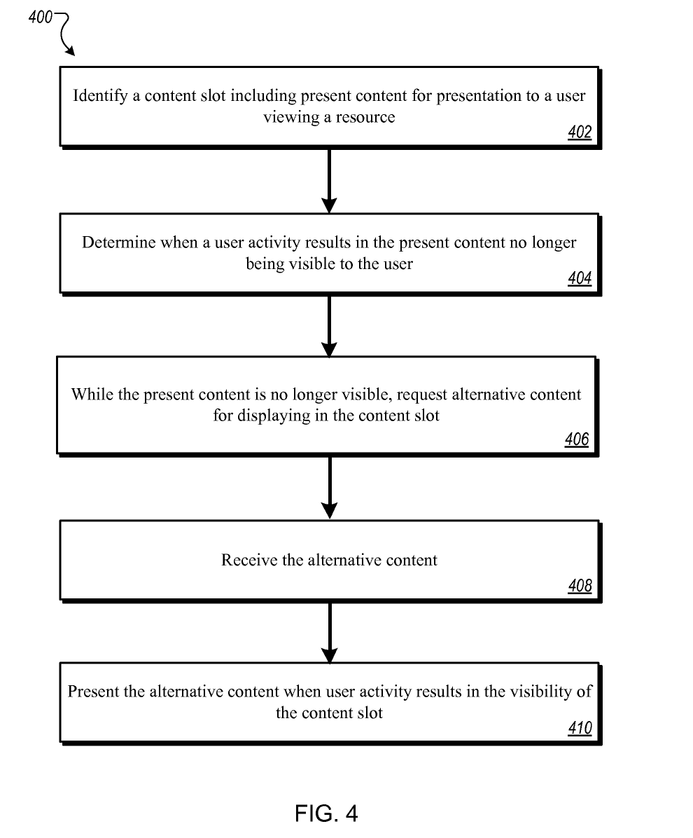

FIG. 4 is a flowchart of an example process 400 for receiving and presenting content to a user. The process 400 can be implemented as one or more computer programs which are stored on computer-readable media and are executable by data processing apparatuses to perform the operations of the process 400. A content slot including present content for presentation to a user is identified (402). For example, a client device (e.g., web browser) may identify a content slot (e.g., the first content slot 212a) including present content (e.g., the first content item 214a) for presentation to a user viewing a resource (e.g., a webpage).

User activity that results in the present content no longer being visible to the user is determined (404). For example, the client device may determine, based on user activity, that the content slot (e.g., the first content slot 212a) in which the present content (e.g., the first content item 214a) is presented to the user is no longer visible to the user (shown in FIG. 2B).

In some implementations, a script (e.g., a piece of Javascript code) is received that is capable of identifying if the content slot is wholly or partially obscured. For example, the client device may receive a script (e.g., from a content management system 110) that, when executed, identifies if the content slot (e.g., the first content slot 212a) is wholly or partially obscured. In some implementations, the script is native to the device used to display the browser (e.g., part of the browser, an operating system, or another application executing on the browser). In some implementations, the script is a tag that fires to request content (e.g., an alternative content item) from a content delivery system (e.g., the content management system 110). In some implementations, the script records user activity and can determine when the user activity results in the content slot being wholly or partially obscured. For example, the script can be a tag that monitors user activity and detects when the content slot is wholly or partially obscured. In some implementations, the script includes one or more criteria for determining whether to request alternative content. Criteria can include the portion of the slot that is obscured (e.g., greater than 50%, the time that the content item has been obscurred (e.g., greater than 1 minute), or other criteria). In some implementations, the sponsor of the content item may include selectable preferences that enable or disable the presentation of alternative content. Other criteria are possible.

Assuming any criteria are satisfied, alternative content is requested (406). For example, when the present content item is no longer visible to the user, the client device may request an alternative content item from the content management system 110 for displaying in the content slot. In some cases, the user may scroll down in a web browser so that the slot in which a content item is presented (e.g., the first content item 212a) becomes no longer visible (shown in FIG. 2B). When the slot is no longer visible, the client device may request an alternative content item from the content management system 110 to be presented in the slot. In some implementations, the request may include a request for a content item to fill the slot and can be based on or reference a result from a prior auction. For example, if a slot, before it is obscured, is presented with a content item from an auction winner, then the client device may request an alternative content item from another content sponsor that participated in the auction (e.g., the content sponsor that placed second in the auction). In some implementations, an alternative auction may be conducted that utilizes different weighting or relevancy scoring. For example, if the user did not select or click on the first content item, different weighting may be used to present a content item that is more relevant and desireable to the user. In some embodiments, the auction for an alternative content item can be based in part on other information received, such as the amount of time the user has spent on the webpage. Alternatively, in some implementations, the alternative content item may be presented to the user with an option (e.g., a button to select) that would re-present the first content item so that the user could have access to the removed content item.

The alternative content is received (408). For example, responsive to the request for an alternative content item to fill the content slot, the content management system 110 may send alternative content to the client device. In some implementations, the client device may request and receive the alternative content from the content management system 110 while the content slot is no longer visible to the user. In some implementations, the client device may request and receive the alternative content item from the content management system 110 prior to user activity that results in the content slot becoming visible to the user (e.g., before the user scrolls upward to move the first content slot 212a back into the visible portion 208a). In some implementations, the script may determine when the content slot is moved to a non-visible portion 208b (e.g., below a lower boundary of the viewport 206 of the web browser that presents the resource), and the content item is delivered to the obscured content slot prior to user activity that results in the content slot surfacing in the view port of the web browser (e.g., above the lower boundary of the viewport 206). For example, once the content slot is obscured (i.e., as opposed to waiting until the slot is re-presented to the user), the content management system 110 may receive the request for an alternative content item and subsequently deliver the alternative content item to the user.

The alternative content is displayed (410). For example, after the alternative content is received from the content management system 110, the client device may present the alternative content when user activity results in the visibility of the content slot. In some implementations, the alternative content item may be presented, for example, when the user navigates or scrolls up or down along a web property such that the content slot in which the alternative content item is delivered and is visible within the viewport 206.

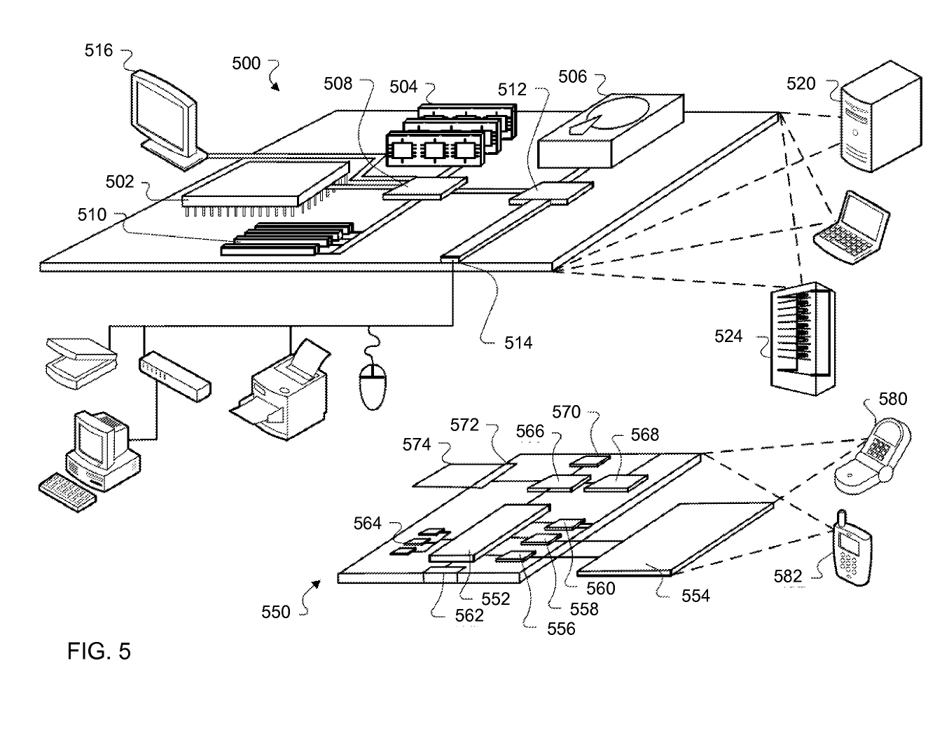

FIG. 5 shows an example of a computing device 500 and a mobile computing device 550 that can be used to implement the techniques described in this disclosure. The computing device 500 is intended to represent various forms of digital computers, such as laptops, desktops, workstations, personal digital assistants, servers, blade servers, mainframes, and other appropriate computers. The mobile computing device 550 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 504 stores information within the computing device 500. In some implementations, the memory 504 is a volatile memory unit or units. In some implementations, the memory 504 is a non-volatile memory unit or units. The memory 504 may also be another form of computer-readable medium, such as a magnetic or optical disk.

The storage device 506 is capable of providing mass storage for the computing device 500. In some implementations, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 502), perform one or more methods, such as those described above. The instructions can also be stored by one or more storage devices such as computer- or machine-readable mediums (for example, the memory 504, the storage device 506, or memory on the processor 502).

The high-speed interface 508 manages bandwidth-intensive operations for the computing device 500, while the low-speed interface 512 manages lower bandwidth-intensive operations. Such allocation of functions is an example only. In some implementations, the high-speed interface 508 is coupled to the memory 504, the display 516 (e.g., through a graphics processor or accelerator), and to the high-speed expansion ports 510, which may accept various expansion cards (not shown). In the implementation, the low-speed interface 512 is coupled to the storage device 506 and the low-speed expansion port 514. The low-speed expansion port 514, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. In addition, it may be implemented in a personal computer such as a laptop computer 522. It may also be implemented as part of a rack server system 524. Alternatively, components from the computing device 500 may be combined with other components in a mobile device (not shown), such as a mobile computing device 550. Each of such devices may contain one or more of the computing device 500 and the mobile computing device 550, and an entire system may be made up of multiple computing devices communicating with each other.

The mobile computing device 550 includes a processor 552, a memory 564, an input/output device such as a display 554, a communication interface 566, and a transceiver 568, among other components. The mobile computing device 550 may also be provided with a storage device, such as a micro-drive or other device, to provide additional storage. Each of the processor 552, the memory 564, the display 554, the communication interface 566, and the transceiver 568, are interconnected using various buses, and several of the components may be mounted on a common motherboard or in other manners as appropriate.

The processor 552 can execute instructions within the mobile computing device 550, including instructions stored in the memory 564. The processor 552 may be implemented as a chipset of chips that include separate and multiple analog and digital processors. The processor 552 may provide, for example, for coordination of the other components of the mobile computing device 550, such as control of user interfaces, applications run by the mobile computing device 550, and wireless communication by the mobile computing device 550.

The processor 552 may communicate with a user through a control interface 558 and a display interface 556 coupled to the display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a SIMM (Single In Line Memory Module) card interface. The expansion memory 574 may provide extra storage space for the mobile computing device 550, or may also store applications or other information for the mobile computing device 550. Specifically, the expansion memory 574 may include instructions to carry out or supplement the processes described above, and may include secure information also. Thus, for example, the expansion memory 574 may be provide as a security module for the mobile computing device 550, and may be programmed with instructions that permit secure use of the mobile computing device 550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. The instructions, when executed by one or more processing devices (for example, processor 552), perform one or more methods, such as those described above. The instructions can also be stored by one or more storage devices, such as one or more computer or machine-readable mediums (for example, the memory 564, the expansion memory 574, or memory on the processor 552). In some implementations, the instructions can be received in a propagated signal, for example, over the transceiver 568 or the external interface 562.

The mobile computing device 550 may communicate wirelessly through the communication interface 566, which may include digital signal processing circuitry where necessary. The communication interface 566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 568 using a radio-frequency. In addition, short-range communication may occur, such as using a Bluetooth, Wi-Fi, or other such transceiver (not shown). In addition, a GPS (Global Positioning System) receiver module 570 may provide additional navigation- and location-related wireless data to the mobile computing device 550, which may be used as appropriate by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound (e.g., voice messages, music files, etc.) and may also include sound generated by applications operating on the mobile computing device 550.

The mobile computing device 550 may be implemented in a number of different forms, as shown in the figure. For example, it may be implemented as a cellular telephone 580. It may also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

What is claimed is:

1. A method comprising:
identifying when a content item that was presented to a user in association with a slot on a resource is not visible to the user, wherein the slot presenting the content item is rendered wholly or partially not visible as a result of user activity;
receiving a request to provide an alternative content item to be presented to the user when user activity enables re-presentation of the slot; and
delivering the alternative content item to a device associated with the user responsive to the request.

2. The method according to claim 1, further comprising providing a script to the resource that, when executed, identifies if the slot is wholly or partially obscured.

3. The method according to claim 2, wherein the script is a tag that fires to request a content item from a content delivery system.

4. The method according to claim 2, wherein the script is a tag that monitors user activity and detects when the slot is wholly or partially obscured.

5. The method according to claim 2, wherein the script determines when the slot is below a lower boundary associated with a user interface that presents the resource, and wherein delivering the alternative content item occurs prior to user activity that results in the slot surfacing above the lower boundary.

6. The method according to claim 2, wherein the script tracks user activity and determines when the user activity results in the slot being wholly or partially obscured.

7. The method according to claim 1, wherein the request comprises a request for a content item to fill the slot based at least in part on a result from a prior auction.

8. The method according to claim 1, wherein receiving the request and delivering the alternative content item occur while the content slot is no longer visible to the user.

9. A method comprising:
in a client device, identifying a content slot including present content for presentation to a user viewing a resource;
determining when a user activity results in the present content either wholly or partially no longer being visible to the user;
while the present content is no longer visible, requesting alternative content for displaying in the content slot;
receiving the alternative content; and
after receiving the alternative content, presenting the alternative content when user activity results in the visibility of the content slot.

10. The method according to claim 9, further comprising receiving a script that, when executed, identifies if the content slot is wholly or partially obscured.

11. The method according to claim 10, wherein the script is a tag that fires to request content from a content delivery system.

12. The method according to claim 10, wherein the script is a tag that monitors user activity and detects when the content slot is wholly or partially obscured.

13. The method according to claim 10, wherein the script determines when the content slot is below a lower boundary associated with a user interface that presents the resource, and wherein receiving the alternative content occurs prior to user activity that results in the content slot surfacing above the lower boundary.

14. The method according to claim 10, wherein the script tracks user activity and determines when the user activity results in the content slot being wholly or partially obscured.

15. The method according to claim 9, wherein the requesting alternative content comprises requesting content to fill the content slot based at least in part on a result from a prior auction.

16. The method according to claim 9, wherein requesting alternative content and receiving the alternative content occur while the content slot is no longer visible to the user.
